(19) United States
(12) Patent Application Publication
(10) Pub. No.: US 2025/0172080 A1
(43) Pub. Date: May 29, 2025

(54) VEHICLE

(71) Applicant: ISUZU MOTORS LIMITED, Yokohama-shi (JP)

(72) Inventors: Tetsuya ASAMI, Fujisawa-shi (JP); Takashi HASEYAMA, Fujisawa-shi (JP); Takashi YAMASHITA, Fujisawa-shi (JP); Takashi ABE, Fujisawa-shi (JP)

(21) Appl. No.: 18/921,341

(22) Filed: Oct. 21, 2024

(30) Foreign Application Priority Data
Nov. 24, 2023 (JP) 2023-198922

(51) Int. Cl. F01N 3/023; F01N 13/10; F02M 26/14

(52) U.S. Cl. CPC F01N 3/023; F01N 13/10; F02M 26/14

(57) ABSTRACT

An object of the present disclosure is to prevent a foreign matter from entering an EGR passage. To achieve the object, a vehicle includes an engine, an exhaust manifold that divides an exhaust gas discharged from cylinders of the engine to cause the exhaust gas to enter and be discharged from an exhaust passage and an EGR passage, an exhaust gas treatment apparatus that is provided in the exhaust passage and includes a filter that collects fine particles in the exhaust gas, and a regeneration process control apparatus that performs post injection to execute a regeneration process of the filter, in which when the post injection is performed, the regeneration process control apparatus stops the post injection from an injector of a cylinder disposed such that a branch section to the EGR passage is located between an exhaust port of the cylinder and the exhaust passage.

### CROSS REFERENCE TO RELATED APPLICATIONS

This application is entitled to (or claims) the benefit of Japanese Patent Application No. 2023-198922, filed on Nov. 24, 2023, the disclosure of which including the specification, drawings and abstract is incorporated herein by reference in its entirety.

### TECHNICAL FIELD

The present disclosure relates to a technique for preventing a foreign matter such as particles composed of soot and hydrocarbons from entering an EGR passage.

### BACKGROUND ART

An exhaust gas, after fuel has been burned in each cylinder of an engine, is collected in an exhaust manifold and is discharged to an outside of a vehicle through an exhaust pipe. In the exhaust pipe, at a position between the both ends thereof, an exhaust gas treatment apparatus for decomposing and removing fine particles (PM) and nitrogen oxides (NOx) in the exhaust gas is provided.

As the exhaust gas treatment apparatus, known is an apparatus that includes a diesel particulate defuser (DPD) including a diesel oxidation catalyst (DOC) and a catalyzed soot filter (CSF), and a selective catalytic reduction (SCR) including a nitrogen oxide reduction catalyst and an ammonia oxidation catalyst. The fine particles in the exhaust gas are collected by the catalyzed soot filter, and the nitrogen oxides are reduced and decomposed by the SCR.

Further, an exhaust gas recirculation (EGR) apparatus is connected to the exhaust manifold, and a part of the exhaust gas is sent to an intake manifold via the EGR apparatus and is mixed with an intake air from the outside of a vehicle. With this configuration, an oxygen concentration in the intake air decreases, a burning temperature in the cylinder decreases, and an amount of the nitrogen oxides in the exhaust gas decreases.

The increase of the soot collected by the catalyzed soot filter would cause clogging, and thus, a regeneration process of the catalyzed soot filter is performed before the clogging is caused. In the regeneration process, unburned fuel is mixed in the exhaust gas by post injection and sent to DPD, the unburned fuel is burned in the presence of the diesel oxidation catalyst to raise the exhaust gas temperature, and the soot in the catalyzed soot filter is burned by the high-temperature exhaust gas, thereby regenerating the catalyzed soot filter (PTL 1 and PTL 2).

### CITATION LIST

### Patent Literature

PTL 1
Japanese Patent Application Laid-Open No. 2005-282479
PTL 2
Japanese Patent Application Laid-Open No. 2011-247143

### SUMMARY OF INVENTION

### Technical Problem

The inventors of the present application have found that, when the regeneration process of a catalyzed soot filter is repeatedly performed, there is a case where particles containing soot are deposited in the EGR passage. Such a deposited material includes mixed particles of the soot in the exhaust gas and hydrocarbons derived from the unburned fuel. Particles entering the EGR passage are cooled, and the hydrocarbons turn into resins and are deposited in the EGR passage. As the deposition of these particles proceeds, there is a possibility that a flow in the EGR passage is hindered.

An object of the present disclosure is to prevent a foreign matter from entering an EGR passage.

### Solution to Problem

A vehicle according to the present disclosure includes: an engine; an exhaust manifold that divides an exhaust gas discharged from cylinders of the engine to cause the exhaust gas to enter and be discharged from an exhaust passage and an EGR passage; an exhaust gas treatment apparatus that is provided at the exhaust passage and includes a filter that collects a fine particle in the exhaust gas; and a regeneration process control apparatus that performs post injection to execute a regeneration process of the filter, in which when the post injection is performed, the regeneration process control apparatus stops the post injection from an injector of at least one cylinder of the plurality of cylinders which is disposed such that a branch section to the EGR passage is located between an exhaust port of the at least one cylinder and the exhaust passage.

### Advantageous Effects of Invention

According to the present disclosure, since unburned fuel is not included in a flow from an exhaust port of a cylinder to an EGR passage, it is possible to prevent particles (foreign matters) containing soot and hydrocarbons from entering an EGR apparatus.

### BRIEF DESCRIPTION OF DRAWINGS

FIG. 1 illustrates an overall configuration;

FIG. 2 illustrates a flow of an exhaust gas; and

FIG. 3 illustrates the flow of the exhaust gas.

### DESCRIPTION OF EMBODIMENTS

Hereinafter, an embodiment of the present disclosure will be described with reference to the drawings. The embodiments described below are all examples of the present disclosure. Therefore, each component, the disposition position and the connection form of each component, and the like illustrated in the following embodiments are examples and are not intended to limit the present disclosure. Each drawing is a schematic diagram and is not necessarily a strict illustration. In each drawing, the same symbol is attached to a substantially identical configuration, and redundant explanations may be omitted or simplified.

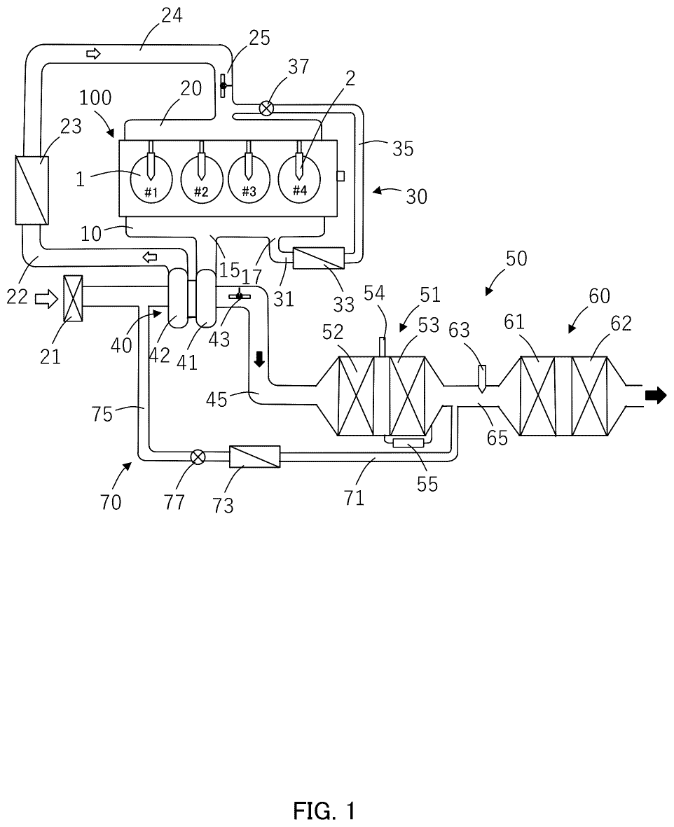

FIG. 1 illustrates a structure around an engine including an intake system and an exhaust system. Plurality of cylinders 1 (four cylinders in the illustrated example) (for indicating individual cylinders, the cylinders may be referred to as cylinders 1-1 to 1-4) are formed in engine body 100. Injectors 2 (which may be referred to as injectors 2-1 to 2-4 for indicating individual injectors) for injecting fuel are provided in respective cylinders 1, and are configured to be able to inject fuel into the interiors of cylinders 1.

The foreign matter in the air taken from the outside of a vehicle is removed by air cleaner 21, and then the air is pressurized by compressor 42 of turbocharger 40, passes through intake pipe 22, is cooled by intercooler 23, and is sent to intake manifold 20 via intake pipe 24. Intake pipe 24 is provided with intake throttle 25 for adjusting the flow rate of the air to be supplied to intake manifold 20. The air sent to intake manifold 20 is distributed to each cylinder 1.

Meanwhile, an exhaust gas generated by burning the fuel in cylinder 1 is collected in exhaust manifold 10 and discharged to the outside of the vehicle from exhaust pipe branch section 15 and through exhaust pipe 45. Turbine 41 of turbocharger 40 is provided at exhaust pipe 45 and rotated by the pressure of the exhaust gas. This rotational force rotates compressor 42. Further, exhaust pipe 45 is provided with exhaust valve 43 for adjusting the flow rate of the exhaust gas. Further, exhaust pipe 45 is provided with exhaust gas treatment apparatus 50 for removing soot (fine particles, PM) and nitrogen oxides (NOx) in the exhaust gas.

Exhaust valve 43 is configured so that by throttling exhaust valve 43, the internal exhaust pressure is increased and the exhaust resistance from cylinder 1 is increased. This increases the rotational resistance of the engine and can enhance the action of the engine brake.

Exhaust gas treatment apparatus 50 includes DPD 51 that collects soot in an exhaust gas and removes the soot via burning, and SCR 60 that decomposes nitrogen oxides in the exhaust gas. DPD 51 includes diesel oxidation catalyst 52, catalyzed soot filter 53, temperature sensor 54, and collection filter differential pressure sensor 55, and the soot in the exhaust gas is collected by catalyzed soot filter 53. DPD 51 may be provided in an engine compartment to improve the mounting property.

As a vehicle travels repeatedly, catalyzed soot filter 53 is clogged with the collected soot. This clogging is detected by measuring the pressure difference between the upstream side and the downstream side of catalyzed soot filter 53 by differential pressure sensor 55.

SCR 60 includes nitrogen oxide reduction catalyst 61, ammonia oxidation catalyst 62, and urea injector 63. When urea solution is supplied from urea injector 63 to an exhaust gas, the urea solution is hydrolyzed to generate ammonia. When the generated ammonia and nitrogen oxides in the exhaust gas are sent to nitrogen oxide reduction catalyst 61, the nitrogen oxides are reduced to generate nitrogen and water. The remaining ammonia is oxidized by ammonia oxidation catalyst 62 provided in the subsequent stage, thereby generating nitrogen and water.

Further, EGR apparatuses 30 and 70 aimed at improving the fuel consumption of the engine and reducing nitrogen oxides in the exhaust gas are provided. Nitrogen oxides are known to be generated by nitrogen and oxygen in the air reacting with each other at a high temperature. Each of EGR apparatuses 30 and 70 mixes the exhaust gas and an intake air of the engine to lower the oxygen concentration in cylinder 1, thereby lowering the burning temperature and reducing the generation amount of the nitrogen oxides.

EGR apparatuses 30 and 70 respectively include high-pressure EGR apparatus 30 and low-pressure EGR apparatus 70. High-pressure EGR apparatus 30 includes high-pressure EGR pipe 31 (upstream-side pipe) branching off from exhaust manifold 10, and sends an exhaust gas to intake manifold 20 via high-pressure EGR cooler 33, high-pressure EGR pipe 35 (downstream-side pipe), and high-pressure EGR valve 37. Meanwhile, low-pressure EGR apparatus 70 includes low-pressure EGR pipe 71 branching off from exhaust gas treatment apparatus 50, and sends an exhaust gas to intake pipe 22 via low-pressure EGR cooler 73, low-pressure EGR pipe 75, and low-pressure EGR valve 77.

When the clogging of catalyzed soot filter 53 progresses and the pressure difference detected by differential pressure sensor 55 becomes equal to or larger than a predetermined value, the regeneration process of catalyzed soot filter 53 is performed. The regeneration process includes automatic regeneration performed while the vehicle is traveling (traveling regeneration process) and manual regeneration performed by an operation of a driver while the vehicle stops. In the regeneration process, when unburned fuel from post injection is sent to DPD 51 together with an exhaust gas, the unburned fuel is burned by diesel oxidation catalyst 52, and the exhaust gas is heated. Then, this heated exhaust gas burns the soot collected by catalyzed soot filter 53.

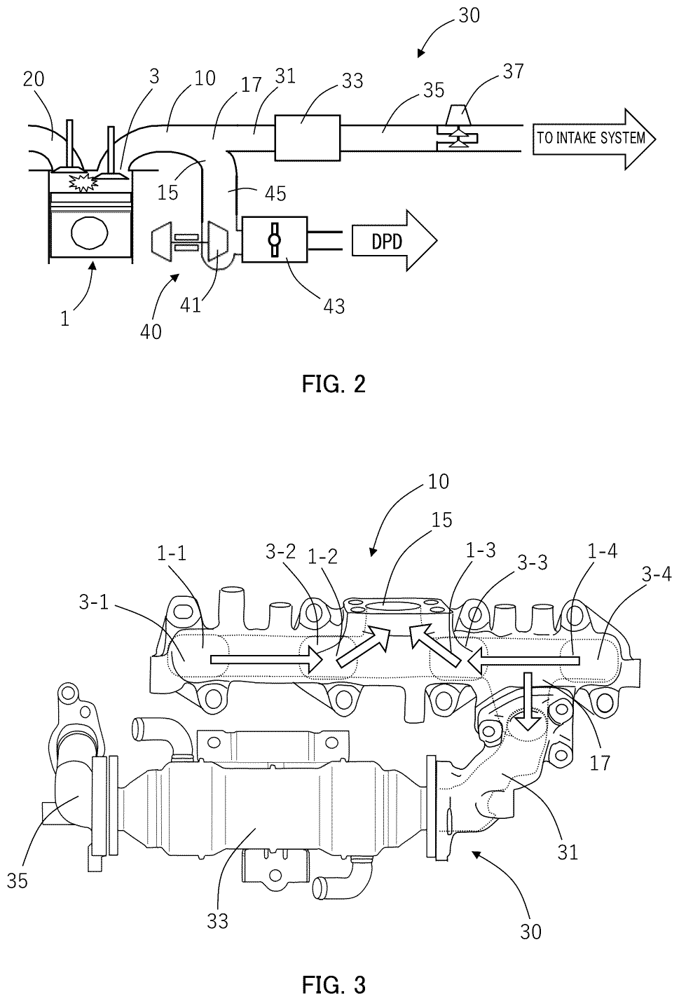

FIG. 2 illustrates an outline of the air supply/exhaust system of cylinder 1. Intake manifold 20 and exhaust manifold 10 are connected to cylinder 1, air for burning is introduced from intake manifold 20, and the exhaust gas after burning is discharged to exhaust manifold 10 through corresponding exhaust port 3 (for indicating individual exhaust ports, the exhaust ports may be referred to as exhaust ports 3-1 to 3-4). Exhaust pipe branch section 15 formed in exhaust manifold 10, and exhaust pipe 45 is connected to exhaust pipe branch section 15. Turbine 41 of turbocharger 40 and exhaust valve 43 are provided at exhaust pipe 45, and a downstream side of exhaust pipe 45 is connected to exhaust gas treatment apparatus 50.

EGR branch section 17 is formed in exhaust manifold 10, and the upstream high-pressure EGR pipe 31 is connected to EGR branch section 17. High-pressure EGR cooler 33 that cools an exhaust gas flowing through high-pressure EGR pipe 31 is provided at high-pressure EGR pipe 31, and the downstream high-pressure EGR pipe 35 is connected to a downstream side of high-pressure EGR cooler 33. High-pressure EGR valve 37 is provided at the downstream high-pressure EGR pipe 35, and the flow rate of the exhaust gas passing through high-pressure EGR apparatus 30 can be controlled. High-pressure EGR pipe 35 is connected to intake manifold 20.

FIG. 3 illustrates the flows of exhaust gases discharged from cylinders 1. Exhaust gases discharged from exhaust ports 3-1 to 3-4 of respective cylinders 1-1 to 1-4 are collected in exhaust manifold 10, and divided into a flow that is discharged from exhaust pipe branch section 15 to exhaust pipe 45, and a flow that is sent from EGR branch section 17 to high-pressure EGR apparatus 30 (see arrows in the drawing).

Although it depends on the opening degree of high-pressure EGR valve 37, mainly the exhaust gas discharged from exhaust port 3-4 of the rightmost cylinder 1-4 in FIG. 3 flows into high-pressure EGR apparatus 30. Meanwhile, the exhaust gas discharged from each of exhaust ports 3-1 to 3-3 of left three cylinders 1-1 to 1-3 in FIG. 3 is discharged to exhaust pipe 45 from exhaust pipe branch section 15.

Next, operations when performing the regeneration process of catalyzed soot filter 53 will be described. When the clogging of catalyzed soot filter 53 progresses, the traveling regeneration process at low speed and low load or the manual regeneration process while the vehicle stops is performed. During the regeneration process, high-pressure EGR valve 37 is closed, and exhaust valve 43 is throttled. In this state, the engine is operated at a low speed or idling. Then, post injection after burning is performed from injectors 2-1 to 2-3 of cylinders 1-1 to 1-3, and the injected fuel is sent to DPD 51 in an unburned state. At this time, injector 2-4 of cylinder 1-4 stops post injection. Here, injector 2-4 of cylinder 1-4 is disposed such that EGR branch section 17 is located between exhaust port 3-4 and exhaust pipe branch section 15.

As described above, by stopping the post injection of the injector 2-4 of cylinder 1-4 (with EGR branch section 17 located between exhaust port 3-4 and exhaust pipe branch section 15) at the time of the regeneration process, it is possible to prevent unburned fuel from flowing into high-pressure EGR pipe 31, and it is possible to prevent soot and hydrocarbon particles from depositing in high-pressure EGR apparatus 30.

While the engine in the above-described embodiment has been described as a four-cylinder engine, the number of cylinders may be any number. Further, the number of cylinders in which the injector is stopped at the time of post injection is determined according to the disposition of the exhaust ports, the exhaust pipe branch sections, and the EGR branch sections in the respective cylinders. That is, when an EGR branch section is disposed between the exhaust port of a cylinder and the exhaust pipe branch section, the intended effect of preventing a foreign matter from entering the EGR passage can be obtained by stopping the post injection of the injector of the cylinder.

The foreign matter entering the EGR passage is more likely to increase in a case of manual regeneration process more than in a case of automatic regeneration process, and thus the regeneration process according to the present disclosure is more effective in a case of manual regeneration process.

### INDUSTRIAL APPLICABILITY

It is possible to satisfactorily prevent a foreign matter from entering EGR.

### REFERENCE SIGNS LIST

1 Cylinder
2 Injector
3 Exhaust port
10 Exhaust manifold
15 Exhaust pipe branch section
17 EGR branch section
20 Intake manifold
30 high-pressure EGR apparatus
31 high-pressure EGR pipe (upstream side)
33 high-pressure EGR cooler
35 high-pressure EGR pipe (downstream side)
37 high-pressure EGR valve
40 Turbocharger
41 Turbine
42 Compressor
43 Exhaust valve
45 Exhaust pipe
50 Exhaust gas treatment apparatus
51 DPD
52 Diesel oxidation catalyst
53 catalyzed soot filter
60 SCR
61 Nitrogen oxide reduction catalyst
62 Ammonia oxidation catalyst
63 Urea injector

1. A vehicle comprising:
an engine;
an exhaust manifold that divides an exhaust gas discharged from cylinders of the engine to cause the exhaust gas to enter and be discharged from an exhaust passage and an EGR passage;
an exhaust gas treatment apparatus that is provided at the exhaust passage and includes a filter that collects a fine particle in the exhaust gas; and
a regeneration process control apparatus that performs post injection to execute a regeneration process of the filter,
wherein
when the post injection is performed, the regeneration process control apparatus stops the post injection from an injector of at least one cylinder of the plurality of cylinders which is disposed such that a branch section to the EGR passage is located between an exhaust port of the at least one cylinder and the exhaust passage.

2. The vehicle according to claim 1, wherein
the regeneration process is a manual regeneration process performed with the engine in an idling state while the vehicle is stopped.
